(19) United States
(12) Patent Application Publication
(10) Pub. No.: US 2011/0049032 A1
(43) Pub. Date: Mar. 3, 2011

(54) DEVICE FOR DISSOLVING OXYGEN INTO WATER AND APPARATUS FOR MAKING SUPEROXYGENATED WATER EMPLOYING THE SAME

(76) Inventors: Jung Seon Cho, Yeosu-si (KR); Hyung Hwa Bae, Seoul (KR)

(21) Appl. No.: 12/446,374

(22) PCT Filed: Oct. 18, 2006
(86) PCT No.: PCT/KR2006/004241

§ 371 Date: Nov. 2, 2010

(51) Int. Cl. C02F 1/72; B01F 3/04

(52) U.S. Cl. 210/203; 261/30; 261/133

(57) ABSTRACT

An apparatus for making oxygenated water capable of producing super oxygenated water and retaining the dissolved oxygen for long time periods, while being applicable to an open reservoir as well as a closed reservoir and having simple structure so as to be implemented in small as well as large size machines. According to an aspect of the present invention, the oxygenating apparatus circulates water contained in a water reservoir and dissolves oxygen from an oxygen source into the circulated water flow. A pump is coupled to the outlet of the water reservoir in fluid communication, and circulates the water contained in the water reservoir. An oxygen dissolving device has an inlet coupled to the pump in fluid communication and an outlet coupled to the water reservoir in fluid communication, and dissolves oxygen from the oxygen source to water supplied by the pump. A plurality of trays are installed in cascade vertically in a housing of the oxygen dissolving device. A water supply tip is coupled to the inlet in fluid communication and provides the water supplied by the pump to a highest tray of the plurality of trays. Pressure maintaining means is coupled to the outlet in fluid communication and maintains internal pressure of the housing in a predetermined range while allowing oxygenated water to return from the outlet to the water reservoir.

### TECHNICAL FIELD

The present invention relates to an apparatus for dissolving gas in liquid and, more particularly, to an apparatus for physically dissolving oxygen in water without using any electrochemical catalysts or additives.

### BACKGROUND ART

Many applications exist that require rapid and efficient dissolution of large amounts of oxygen into large volume of water. For example, the oxygenation of water is used in water treatment applications in industrial plants, such as chemical plants, paper mills, and many other similar operations, because oxygen accelerates the activation of aerobes. That is, enrichment of the oxygen content in water enhances the efficiency of water purification by facilitating bacterial decomposition of contaminating organic matter. Besides, the oxygenated water is utilized in commercial fish farming and hydroponic culture of vegetables.

Meanwhile, it is also known that oxygenated water is beneficial to a human body. The consumption of oxygen-enriched water increases oxygen contents in the blood of a human body, which facilitates the metabolism of the ingested human body and brings about various beneficial results. An athlete can enhance physical exercise capabilities without increasing the pulse rate owing to a pulmonary function bypass. Also, the oxygen is useful to students because some of the oxygen reinforced in the blood stream is fed to the cerebrum to increase thinking power and concentration and reduce stress.

The most typical attempts for dissolving oxygen into water involve the introduction of oxygen rich gas into water by means such as bubbling to increase the interfacial contact of oxygen and water. Even though allowing a dissolved oxygen level near a saturation level, this method cannot be utilized for applications which require super saturation of oxygen because of low dissolving efficiency. Further, this method is disadvantageous in that the dissolved oxygen can easily be evaporated from the oxygenated water, which makes the method substantially impossible to be used for applications for making super oxygenated water.

Another conventional technique for raising the oxygen content of water is filling oxygen and water in an airtight vessel and maintaining the contents for long time under pressure so that the oxygen is dissolved into the water. However, because the implementation of such a method requires a rigid vessel, a high-head pump, and a high-pressure oxygen tank, the method has drawbacks that the system is bulky and heavy, and manufacturing cost of the oxygenated water is high. Thus, this approach substantially cannot be applied to an open reservoir. Further, this method cannot be utilized for common consumer product applications such as a bottled water dispenser and a water purifier because of high volume, weight, manufacturing cost, and noise. Therefore, it is required to develop an oxygenating apparatus capable of producing super oxygenated water, while being applicable to an open reservoir and having simple structure, occupying less volume, having less weight, and generating little noise so as to be utilized for common consumer product applications such as a bottled water dispenser and a water purifier.

### DISCLOSURE

### Technical Problem

To solve the above problems, one object of the present invention is to provide an oxygenating apparatus capable of producing super oxygenated water and retaining the dissolved oxygen for long time periods, while being applicable to an open reservoir as well as a closed reservoir and having simple structure so as to be implemented in small as well as large size machines. Another object of the present invention is to provide a water purifier employing such an oxygenating apparatus.

The other object of the present invention is to provide a water dispenser employing such an oxygenating apparatus.

### Technical Solution

The operating principle of an oxygenating apparatus can theoretically be explained by two-film theory. [Lewis and Whitman, The two-film theory of gas absorption. Ind. Eng. Chem., 16, 1215 (1924)]. According to the two-film theory, the mass transfer coefficient can be expressed as:

$$\frac{d m}{d t} = K g A ( C s - C )$$

where dm/dt denotes the mass transfer coefficient, Kg denotes diffusion coefficient of gas, A denotes interfacial area, Cs denotes saturated concentration of gas in liquid, and C denotes current concentration of gas in liquid. As can be seen in the equation, the mass transfer is proportional to the interfacial area of the liquid-phase material and the gas-phase material. Thus, dissolved oxygen level of water can be maximized by increasing the interfacial area of oxygen bubble and water. That is, the smaller the oxygen bubbles are that are in contact with the water, the faster the oxygen will dissolve.

Based on theoretical principle, the oxygenating apparatus of the present invention encourages oxygen bubbles to be divided into smaller ones and induces friction between water and oxygen bubbles to increase the interfacial area of the water and oxygen bubbles and facilitate rapid dissolution and super saturation of dissolved oxygen in the water.

According to an aspect of the present invention, an apparatus for making oxygenated water, which is suitable for circulating water contained in a water reservoir and dissolving oxygen from an oxygen source into the circulated water flow, includes a pump, the plurality of vertical dissolving units, a turbulent dissolving tube, and a mixer. The pump is coupled to the outlet of the water reservoir in fluid communication, and circulates the water contained in the water reservoir. The plurality of vertical dissolving units are connected serially and coupled to the pump in fluid communication, and each vertical dissolving unit has a top inlet and a bottom outlet. The turbulent dissolving tube has an inlet connected to the outlet of the last one of the plurality of vertical dissolving units and an outlet coupled to the water reservoir in fluid communication, and introduces turbulence in water/oxygen admixture. The mixer is provided in the fluid path between the outlet of the water reservoir and the vertical dissolving units, and distributes oxygen from an oxygen source as bubbles in the water to produce the oxygen/water admixture. Preferably, the apparatus for making oxygenated water includes a vertical panel and a plurality of couples of clips disposed on the lateral side of the vertical panel, and the plurality of vertical dissolving units are fixed by the plurality of couples of clips. The plurality of vertical dissolving units take the role of a bobbin, and the turbulent dissolving tube are wound around the vertical dissolving units assembly.

The oxygenating apparatus can be applied to the water dispenser or the water purifier to be manufactured as a single body. Alternatively, however, the oxygenating apparatus can be installed outside the water dispenser or the water purifier, so as to receive water from the water dispenser or the water purifier and returns oxygenated to the water dispenser or the water purifier.

In an embodiment of the water dispenser, a upper pad is used for mounting a water bottle, a cold water tank contains cold water, a cooling coil is wrapped around the outer surface of the cold water tank, and a cold water tap is connected to the cold water tank. For dissolving oxygen from an oxygen source to water supplied from the cold water tank, the water dispenser includes a pump, the plurality of vertical dissolving units, a turbulent dissolving tube, and a mixer. The pump is coupled to the outlet of the cold water tank in fluid communication, and circulates the water contained in the cold water tank. The plurality of vertical dissolving units are connected serially and coupled to the pump in fluid communication, and each vertical dissolving unit has a top inlet and a bottom outlet. The turbulent dissolving tube has an inlet connected to the outlet of the last one of the plurality of vertical dissolving units and an outlet coupled to the cold water tank in fluid communication, and introduces turbulence in water/oxygen admixture. The mixer is provided in the fluid path between the outlet of the cold water tank and the vertical dissolving units, and distributes oxygen from an oxygen source as bubbles in the water to produce the oxygen/water admixture.

In an embodiment of the water purifier, water supplied through a tap line is filtered by a plurality of filters and stored in a reservoir, and the reservoir is connected to a water tap extending from front face of the water purifier. For dissolving oxygen from an oxygen source to water supplied from the reservoir, the water purifier includes a pump, the plurality of vertical dissolving units, a turbulent dissolving tube, and a mixer. The pump is coupled to the outlet of the reservoir in fluid communication, and circulates the water contained in the reservoir. The plurality of vertical dissolving units are connected serially and coupled to the pump in fluid communication, and each vertical dissolving unit has a top inlet and a bottom outlet. The turbulent dissolving tube has an inlet connected to the outlet of the last one of the plurality of vertical dissolving units and an outlet coupled to the reservoir in fluid communication, and introduces turbulence in water/oxygen admixture. The mixer is provided in the fluid path between the outlet of the reservoir and the vertical dissolving units, and distributes oxygen from an oxygen source as bubbles in the water to produce the oxygen/water admixture.

According to another aspect of the present invention, an apparatus for making oxygenated water circulates water contained in a water reservoir and dissolves oxygen from an oxygen source into the circulated water flow. A pump is coupled to the outlet of the water reservoir in fluid communication, and circulates the water contained in the water reservoir. An oxygen dissolving device has an inlet coupled to the pump in fluid communication and an outlet coupled to the water reservoir in fluid communication, and dissolves oxygen from the oxygen source to water supplied by the pump. The oxygen dissolving device includes a plurality of trays installed in cascade vertically in a housing. A water supply tip is coupled to the inlet in fluid communication and provides the water supplied by the pump to a highest tray of the plurality of trays. Pressure maintaining means is coupled to the outlet in fluid communication and maintains internal pressure of the housing in a predetermined range while allowing oxygenated water to return from the outlet to the water reservoir.

In a preferred embodiment, a mixer is provided in the fluid path between the outlet of the water reservoir and the oxygen dissolving device, and distributes oxygen from the oxygen source as bubbles in the water to produce the oxygen/water admixture. Alternatively, however, the oxygen dissolving device may have an oxygen inlet, so that the oxygen from the oxygen source is directly injected to the oxygen dissolving device through the oxygen inlet.

The outlet of the oxygen dissolving device may be formed in lower section of the oxygen dissolving device. However, the outlet of the oxygen dissolving device may is formed in upper section of the oxygen dissolving device. In such a case, the water aggregating in the lower section of the oxygen dissolving device is conveyed to the outlet of the oxygen dissolving device owing to the internal pressure of the oxygen dissolving device.

The pressure maintaining means may include a solenoid valve, a needle valve, or a combination thereof.

Such an oxygenating apparatus can also be applied to a water dispenser or a water purifier.

In an embodiment of the water dispenser, a upper pad is used for mounting a water bottle, a cold water tank contains cold water, a cooling coil is wrapped around the outer surface of the cold water tank, and a cold water tap is connected to the cold water tank. For dissolving oxygen from an oxygen source to water supplied from the cold water tank, the water dispenser includes a pump and an oxygen dissolving device. The pump is coupled to the outlet of the cold water tank in fluid communication, and circulates the water contained in the cold water tank. The plurality of vertical dissolving units are connected serially and coupled to the pump in fluid communication, and each vertical dissolving unit has a top inlet and a bottom outlet. The turbulent dissolving tube has an inlet connected to the outlet of the last one of the plurality of vertical dissolving units and an outlet coupled to the cold water tank in fluid communication, and introduces turbulence in water/oxygen admixture. The mixer is provided in the fluid path between the outlet of the cold water tank and the vertical dissolving units, and distributes oxygen from an oxygen source as bubbles in the water to produce the oxygen/water admixture.

In an embodiment of the water purifier, water supplied through a tap line is filtered by a plurality of filters and stored in a reservoir, and the reservoir is connected to a water tap extending from front face of the water purifier. For dissolving oxygen from an oxygen source to water supplied from the reservoir, the water purifier includes a pump and an oxygen dissolving device. The pump is coupled to the outlet of the water reservoir in fluid communication, and circulates the water contained in the water reservoir. The plurality of vertical dissolving units are connected serially and coupled to the pump in fluid communication, and each vertical dissolving unit has a top inlet and a bottom outlet. The turbulent dissolving tube has an inlet connected to the outlet of the last one of the plurality of vertical dissolving units and an outlet coupled to the water reservoir in fluid communication, and introduces turbulence in water/oxygen admixture. The mixer is provided in the fluid path between the outlet of the water reservoir and the vertical dissolving units, and distributes oxygen from an oxygen source as bubbles in the water to produce the oxygen/water admixture.

### ADVANTAGEOUS EFFECTS

The oxygenating apparatus of the present invention is simple and small in its structure, and can be manufactured inexpensively, but is capable of efficiently producing super oxygenated water and retaining the dissolved oxygen for long periods. Also, the operation cost may be minimized since the apparatus is controlled to maintain a standby state after a number of oxygen dissolving cycles required for attaining desired dissolved oxygen level.

### DESCRIPTION OF DRAWINGS

The above objectives and advantages of the present invention will become more apparent by describing in detail preferred embodiments thereof with reference to the attached drawings, in which:

FIG. 1 illustrates one embodiment of an apparatus for making oxygenated water according to the present invention;

FIG. 2 illustrates a turbulent dissolving tube wrapped around first through fourth dissolving unit;

FIG. 3 illustrates fluid flux in the first through fourth dissolving unit shown in FIG. 2;

FIG. 4 illustrates another embodiment of the apparatus for making superoxygenated water according to the present invention;

FIG. 5 is an exploded view of an oxygen dissolving device shown in FIG. 4;

FIG. 6 is a sectional view of the oxygen dissolving device shown in FIG. 4;

FIG. 7 illustrates an embodiment of the trays and the interconnection of the trays and the internal conveyance pipe;

FIG. 8 illustrates another embodiment of the trays and the interconnection of the trays and the internal conveyance pipe; and

FIG. 9 illustrates another embodiment of a tray assembly.

### MODE FOR INVENTION

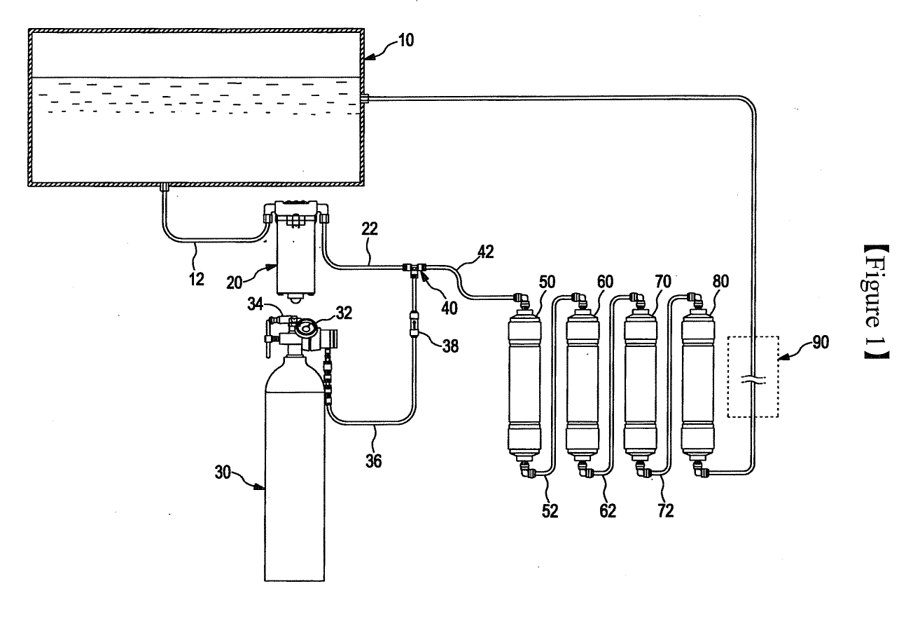

FIG. 1 illustrates one embodiment of an apparatus for making oxygenated water according to the present invention. The apparatus shown in the drawing dissolves oxygen in the water contained in the reservoir 10 to return the oxygenated water to the reservoir 10, and includes a pump 20, an oxygen source 30, a mixer 40, a first through a fourth dissolving units 50-80, and a turbulent dissolving tube 90.

The pump 20 has an inlet connected to the outlet of the water reservoir 10 through a first connection tube 12 and an outlet connected to the mixer 40 through a second connection tube 22 to enable the water contained in the water reservoir 10 to be circulated through the mixer 40, the first through the fourth dissolving units 50-80, and the turbulent dissolving tube 90 so that oxygen is dissolved into the water.

Preferably, the oxygen source 30 is an oxygen tank filled with compressed oxygen gas. The oxygen source 30 is equipped with an oxygen gauge 26 for measuring oxygen flow and a valve 34 for selectively blocking the oxygen supply. Alternatively, however, an oxygen generator, e.g., a pressure swing absorption (PSA) type, a membrane type, or an electrolytic type oxygen generator, can suitably be used for the oxygen source 30. Such an oxygen source may be external to the apparatus as well.

A first inlet of the mixer 40 is connected to the outlet of the pump 20 through the second connection tube 22, and a second inlet of the mixer 40 is connected to the oxygen source 30 through a third connection tube 36, so that the oxygen gas provided by the oxygen source 30 is distributed into the water flow as bubbles. In a preferred embodiment, the mixer 40 is implemented using a tee fitting. Alternatively, however, the mixer 40 may be implemented using a venturi-type injector or another equivalent means. Meanwhile, a check valve 38 is provided in the third connection tube 36 for preventing the backflow of the oxygen or the water. Each of the first through the fourth dissolving units 50-80 has a shape of a cylindrical vessel having an inlet and an outlet on the upper and lower surfaces, respectively. Each of the upper inlet and lower outlet of the dissolving units 50 through 80 is provided with an elbow fitting for adopting respective connection tubes. The inlet of the first dissolving unit 50 is connected to the outlet of the mixer 40 through a fourth connection tube 42, the inlet of the second dissolving unit 60 is connected to the outlet of the first dissolving unit 50 through a fifth connection tube 52, the inlet of the third dissolving unit 70 is connected to the outlet of the second dissolving unit 60 through a sixth connection tube 62, and the inlet of the fourth dissolving unit 80 is connected to the outlet of the third dissolving unit 70 through a seventh connection tube 72. The dissolving units 50-80 interconnected as above dissolves oxygen diffused in the water/oxygen admixture into the water to a supersaturated level.

The outlet of the fourth dissolving unit 80 is connected to the reservoir 10 through the turbulent dissolving tube 90. The turbulent dissolving tube 90 is made of Nylon or other kinds of synthetic resins, and has a length from 8 to 40 meters. The turbulent dissolving tube 90 is wrapped around the first through fourth dissolving units 50-80. The turbulent dissolving tube 90 introduces turbulence in the water/oxygen admixture to enable most residual oxygen gas to be dissolved into water and thereby increase the dissolved oxygen (DO) level of the water. The outlet of the turbulent dissolving tube 90 is connected to the water reservoir 10, so that the oxygenated water returns to the water reservoir 10.

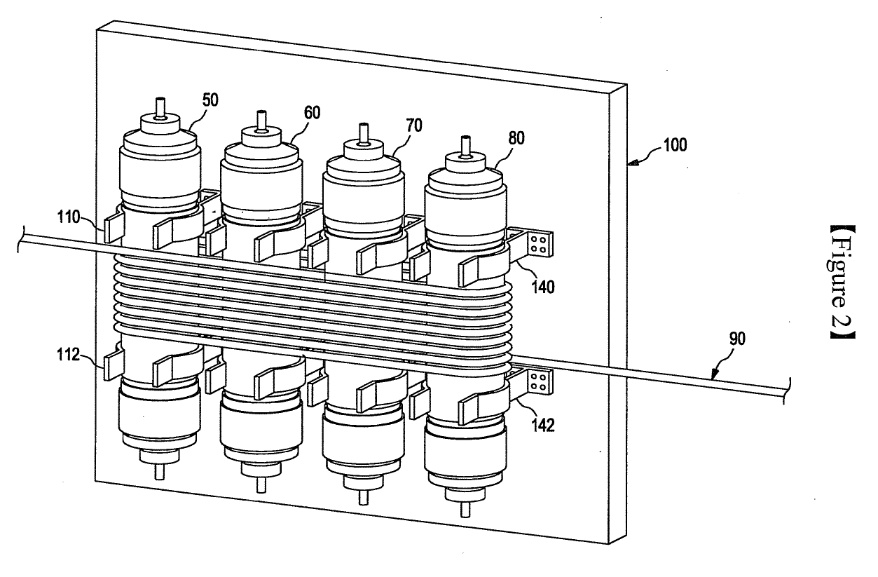

FIG. 2 illustrates an example of the turbulent dissolving tube wrapped around first through fourth dissolving units 50-80. Eight clips 110-142 are attached on a vertical panel 100 for installing the dissolving units by use of screws, and each of the dissolving units is fixed on the lateral side of the vertical panel 100 by a couple of clips. For example, the first dissolving unit 50 is fixed by locating into the first and second clips 110 and 112, the second dissolving unit 60 is fixed by locating into the third and fourth clips, the third dissolving unit 70 is fixed by locating into the fifth and sixth clips, and the fourth dissolving unit 80 is fixed by locating into the seventh and eighth clips. In such a state, the turbulent dissolving tube 90 is wrapped around the outer surfaces of the first through fourth dissolving units 50-80. The vertical panel 100 loaded with the dissolving units 50-80 and the turbulent dissolving tube 90 is fixed inside the housing of an appliance such as a water dispenser or a water purifier.

The apparatus of FIG. 1 operates as follows.

The water contained in the reservoir 10 is supplied to the inlet of the pump 20 and is forced under pressure to be supplied to the mixer 40 through the second connection tube 22. The oxygen supplied from the oxygen source 30 is introduced to the mixer 40 to be mixed with water. The admixture of water and oxygen mixed by the mixer 40 is supplied to the inlet of the first dissolving unit 50 through the fourth connection tube 42.

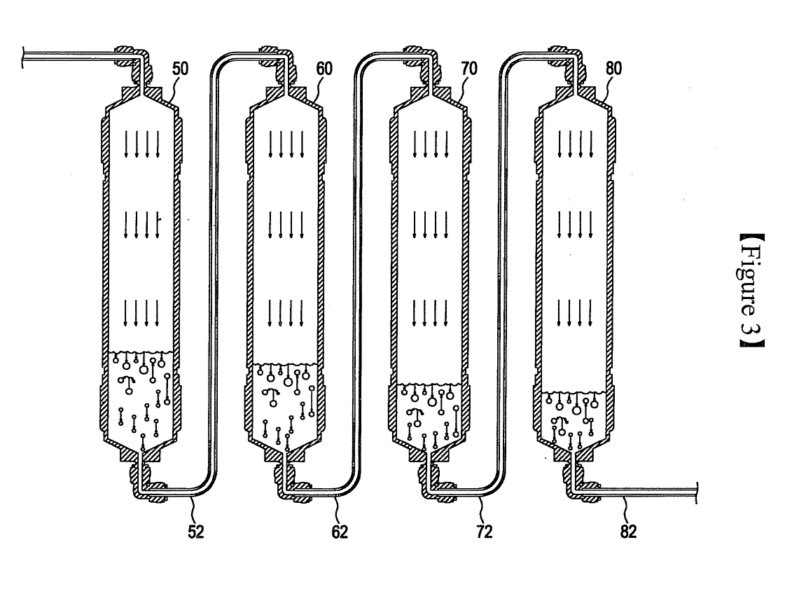

The admixture of water and oxygen supplied to the inlet of the first dissolving unit 50 falls downward in the first dissolving unit 50 due to gravity as shown in FIG. 3. The falling admixture flux collides with surface of admixture contained in the first dissolving unit 50, and thus multiple fine bubbles are generated in the admixture contained in the first dissolving unit 50. Some oxygen bubbles contained in the turbulent water/oxygen admixture float upward due to buoyancy and aggregate in the upper section of the first dissolving unit 50. The pure oxygen in the upper section of the first dissolving unit 50 provides internal aeration of the water under pressure and contributes to the absorption of oxygen by the water.

Meanwhile, the admixture including most bubbles having not floated upward flows downward due to the downward internal pressure in the first dissolving unit 50. Floating bubbles collide with downward admixture flux to be split into smaller ones and are forced to direct downward by the downward admixture flux. Some bubbles in the admixture flux float upward due to buoyancy before arriving at the lower outlet, but collide with the downward flux to be swept away by the flux, which process happens randomly and repetitively. The bubbles in the admixture are split into fine bubbles through such random and repetitive migration, which compels more oxygen to physically be dissolved into water and increases the dissolved oxygen level in water gradually. As described above, the first dissolving unit 40 facilitates splitting of large bubbles into smaller ones, and provides increased residence time for the oxygen in the admixture, during which the oxygen is allowed to be absorbed into the admixture to the highest degree.

The water/oxygen the admixture containing fine bubbles exits the outlet of the first dissolving unit 50 owing to the downward internal pressure and proceeds, through the fifth connection tube 52, to the inlet of the second dissolving unit 60, which allows additional oxygen to be dissolved into water.

The admixture flow and the oxygen dissolving process in the second dissolving unit 60 are similar to those in the first dissolving unit 50. That is, the water/oxygen admixture supplied to the inlet of the second dissolving unit 60 falls downward in the second dissolving unit 60 due to gravity. The falling admixture flux collides with surface of admixture contained in the second dissolving unit 60, and thus multiple micro bubbles are generated in the admixture contained in the second dissolving unit 60. Some oxygen bubbles contained in the turbulent water/oxygen admixture in the second dissolving unit 60 float upward due to buoyancy and aggregate in the upper section of the second dissolving unit 60. The pure oxygen in the upper section of the second dissolving unit 60 provides internal aeration of the water under pressure and contributes to the absorption of oxygen by the water.

Meanwhile, the admixture including most bubbles having not floated upward flows downward due to the downward internal pressure in the second dissolving unit 60. Floating bubbles collide with downward admixture flux to be split into smaller ones and are forced to direct downward by the downward admixture flux. Some bubbles in the admixture flux float upward due to buoyancy before arriving at the lower outlet, but collide with the downward flux to be swept away by the flux, which process happens randomly and repetitively. The bubbles in the admixture are split into micro bubbles through such random and repetitive migration, which compels more oxygen to physically be dissolved into water and increases the dissolved oxygen level in water gradually. The water/oxygen the admixture containing micro bubbles exits the outlet of the second dissolving unit 60 owing to the downward internal pressure and proceeds, through the sixth connection tube 62, to the inlet of the third dissolving unit 70, which allows additional oxygen to be dissolved into water.

The admixture flow and the oxygen dissolving process in the third and fourth dissolving units 70 and 80 are similar to those in the first and second dissolving units 50 and 60. Consequently, in the first through fourth dissolving units 50-80, the oxygen bubbles are split into micro bubbles and the interfacial area of oxygen bubbles and water is increased, which facilitate more oxygen to physically be dissolved into water.

The admixture of water and micro bubbles having passed the fourth dissolving unit 80 is supplied to the turbulent dissolving tube 90, which forces residual oxygen gas in the admixture to be dissolved thoroughly into water. The geometry of the turbulent dissolving tube 90 having multiple curves introduces turbulence in the admixture flux traveling through the tube. The turbulence forces most residual oxygen gas in the admixture to be dissolved into water. Accordingly, most residual oxygen bubbles in the admixture having passed the dissolving units 50-80 is dissolved into water in the turbulent dissolving tube 90.

The oxygenated water flowing out from the outlet of the turbulent dissolving tube 90 returns to the reservoir 10 to be mixed with the water contained therein. Afterwards, the oxygenated water contained in the reservoir 10 is again introduced to the mixer 40 by the pump 20 to be thoroughly enriched with oxygen by the mixer 4, the dissolving units 50-80, and the turbulent dissolving tube 90. Such a recirculation process continues until a desired dissolved oxygen (DO) level is achieved.

*53 The apparatus of the present invention can be implemented to have a compact size, and easily can be applied to a water dispenser or a water purifier.

A water dispenser generally includes a upper pad for mounting a water bottle, a cold water tank for containing cold water, and a cooling coil wrapped around the outer surface of the cold water tank. The cold water tank is connected to a cold water tap extending from the front of the cabinet. The oxygenating apparatus of the present invention can be applied to such a water dispenser by connecting the first connection tube 12 and the turbulent dissolving tube 90 to the cold water tank, and disposing all the other components except the cold water tank in the lower section of the cabinet. In the water dispenser, the oxygenating apparatus circulates the cold water to dissolve oxygen into water. Detailed description of the oxygenating water dispenser is omitted since those skilled in the art can easily implement it based on the above description and the attached drawings along with a literature regarding a conventional water dispenser such as the Korean Patent Publication No. 202612.

On the other hand, a water purifier has a configuration similar to that of the water dispenser except that the water bottle mounting structure is replaced by filters for filtering tap water. The oxygenating apparatus of the present invention can be applied to the water purifier by connecting the first connection tube 12 and the turbulent dissolving tube 90 to the water tank, and disposing all the other components except the water tank in the lower section of the cabinet. Detailed description of the oxygenating water purifier is omitted since those skilled in the art can easily implement it based on the above description and the attached drawings along with a literature regarding a conventional water dispenser such as the Korean Utility Model Registration No. 273318.

The apparatus of FIG. 1 can be modified in various manners as well. For example, though it was described that the mixer 40 is disposed between the pump 20 and the first dissolving unit 50, the mixer 40 may be disposed between the outlet of the reservoir 10 and the pump 20 alternatively.

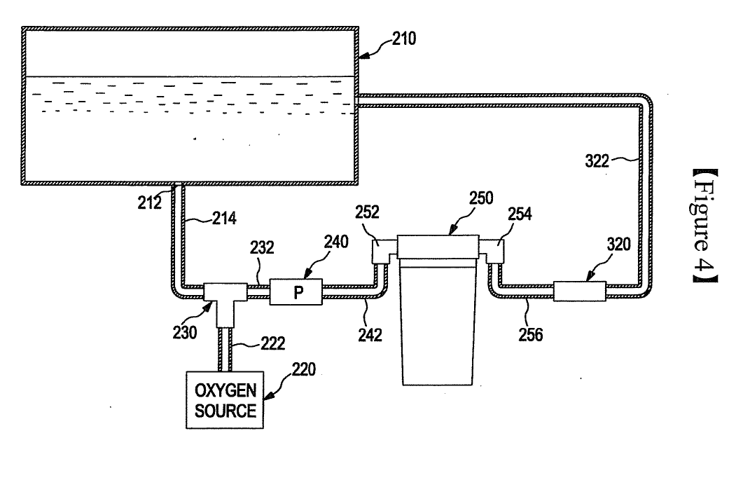

FIG. 4 illustrates another embodiment of the apparatus for making superoxygenated water according to the present invention. The apparatus shown in FIG. 4, which dissolves oxygen in the water contained in the reservoir 210 to return the oxygenated water to the reservoir 210, includes an oxygen source 220, a mixer 230, a pump 240, an oxygen dissolving device 250, and a regulating valve 320.

*58 The mixer 230 can be implemented using a tee fitting. Alternatively, however, the mixer 230 may be implemented using a venturi-type injector or another equivalent means. Preferably, a first inlet of the mixer 230 is connected to the outlet of the reservoir 210 through a first connection tube 214, and a second inlet of the mixer 230 is connected to the oxygen source 220 through a second connection tube 222, so that the oxygen gas provided by the oxygen source 220 is distributed into the water flow as bubbles. In a preferred embodiment suitable for a water dispenser or a water purifier, the oxygen source 220 is an oxygen tank filled with compressed oxygen gas or an electrolytic type oxygen generator, and is capable of providing oxygen gas at a rate of 30 milliliters per minute. The oxygen source 220 may be equipped with an oxygen gauge for measuring oxygen flow and a valve for regulating the oxygen supply. Alternatively, however, the pressure swing absorption (PSA) type or a membrane type oxygen generator can be used for the oxygen source 220. Such an oxygen source 220 may be external to the apparatus as well.

The pump 240 has an inlet connected to the outlet of the mixer 230 through a third connection tube 232 and an outlet connected to the oxygen dissolving device 250 through a third connection tube 242 to enable the water contained in the water reservoir 210 to be circulated through the mixer 230 and the oxygen dissolving device 250 so that oxygen gas is dissolved into the water. Preferably, the pump 240 is implemented by a diaphragm pump, which facilitates the introduction of the oxygen gas from the oxygen source 220 into the mixer 230.

The first elbow fitting 252 is attached to the inlet of oxygen dissolving device 250 and connected to the forth connection tube 242. The outlet of oxygen dissolving device 250 has the second elbow fitting 254 which is connected to the fifth connection tube 256. The oxygen dissolving device 250 dissolves diffused oxygen with bubble-shape in the admixture introduced through the fourth connection tube 242 into the water up to the supersaturated level. Detailed configuration and operation of the oxygen dissolving device 250 will be described below.

The regulating valve 320 has an inlet coupled to the oxygen dissolving device 250 by a fifth connection tube 56 and an outlet coupled to the reservoir 210 by a sixth connection tube 322. The regulating valve 320 maintains the internal pressure of the oxygen dissolving device 250 when the oxygenating apparatus is working, while blocking fluid communications when the apparatus is not working. The regulating valve 320 may be implemented by a needle valve, a solenoid valve, or a combination thereof.

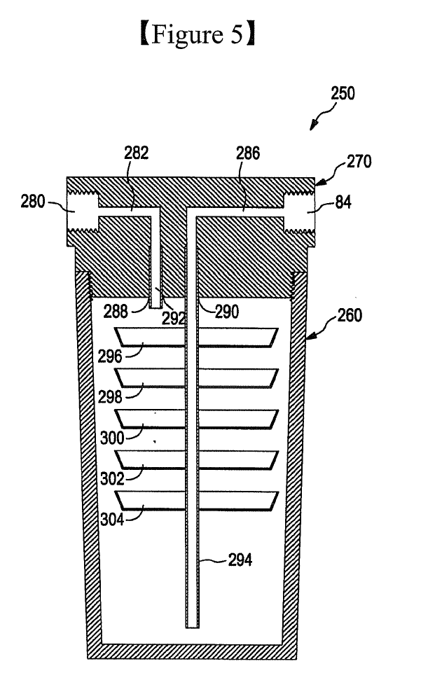

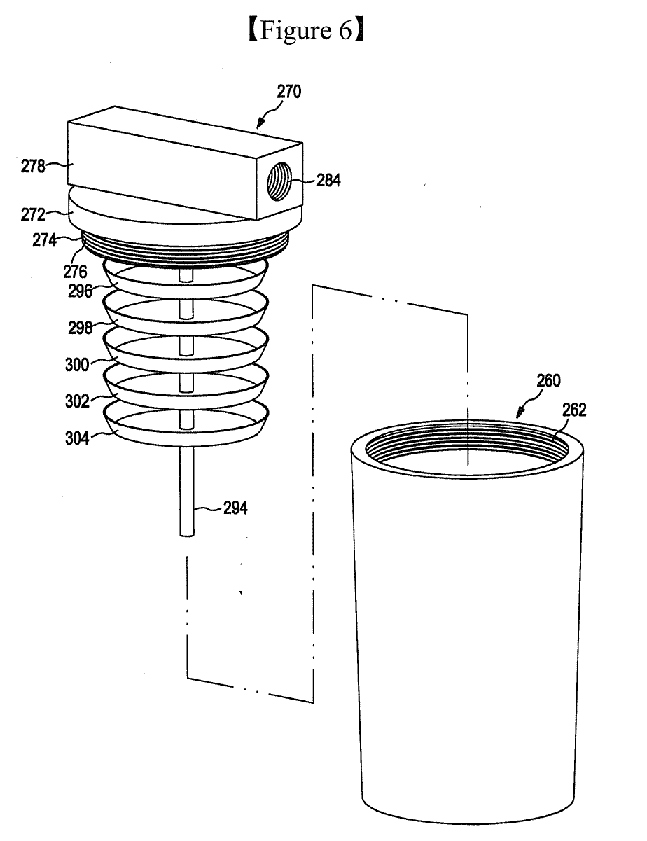

FIG. 5 is an exploded view of the oxygen dissolving device 250, and FIG. 6 is a sectional view of the oxygen dissolving device 250. The oxygen dissolving device 250 includes a lower housing 260 and a lid/tray assembly 270 inserted downward from the upper position of the lower housing 260 to be combined with the lower housing 260.

The lower housing 260 generally has a shape of a cup, and is formed with a screw thread 262 on its top inner surface for engaging with the lid/tray assembly 270. While the lower housing 260 has a shape that the bottom diameter is smaller than the top diameter in the embodiment shown in the drawings, the bottom diameter may be the same as the top diameter alternatively. Meanwhile, the lower housing 260 may have a rectangular or the other kind of cross section rather than a circular cross section.

The lid/tray assembly 270 includes a disk-shaped lid 272, an engagement portion 274 provided beneath the lid 272, and a manifold 278 provided on the lid 278. The engagement portion 274, of which diameter is smaller than that of the lid 272, is formed with a screw thread 276 corresponding to the screw thread 262 of the lower housing 260. It is preferable that the diameter of the lid 272 is almost the same as that of the top outer diameter of the lower housing 260. Inside the manifold 278, is provided fluid paths 282 and 286 extending to the inlet 280 and the outlet 284, respectively, of the oxygen dissolving device. Preferably, the lid 272, the engagement portion 274, and the manifold 278 is formed as a single body. Alternatively, however, the lid 272, the engagement portion 274, and the manifold 278 may be manufactured into two or more combinable parts.

On the bottom surface of the engagement portion 274, is formed a first recess 288 extending upward to the first fluid path 282 and accommodating a water supply tip 292. Also, a second recess 290 is formed on the center of the engagement portion 274 extending upward to the second fluid path 286 and accommodating an internal conveyance pipe 294. The internal conveyance pipe 294 has a length that its lower end positions just above the bottom of the lower housing 260 when the oxygen dissolving device 250 is completely assembled. Along the internal conveyance pipe 294, multiple horizontal trays 296-304 are installed in cascade vertically. Each of the trays 296-304 has an insertion hole in its center, so that the internal conveyance pipe 294 penetrates the insertion holes of the trays 29-204. On the other hand, the water supply tip 292 is installed in such a manner that the lower end of the tip 292 positions above the first tray 296.

In a preferred embodiment, each of the trays 296-304 has the shape of a dish having small vertical dimension, so that the trays 296-304 occupies less space while maximizing the interfacial area between the water and the oxygen gas aggregated in the upper section of the oxygen dissolving device. Alternatively, however, each of the trays 296-304 may have the shape of a cup or a bowl having sufficient vertical dimension, so that the bubbles being introduced in the water owing to the water drops interfaces with the water as much as long time. It is preferable that the bottom diameter of each tray is smaller than its top diameter regardless of the ratio between the average diameter and the height, so that the water overflowing the tray falls onto the water surface of the next tray and introduces sufficient collision and friction with the water/oxygen admixture contained therein. Further, the cross section of each tray may be larger than that of its upper tray to ensure that the water overflowing a tray falls onto the next tray. Meanwhile, it is possible to form multiple openings penetrating each of the first through the fifth trays 296-304, so that the water contained in each tray may flow down through the openings to further increase the interfacial area between the water and the oxygen gas. On the other hand, in an alternative embodiment, the first through the fifth trays 296-304 may be flat plates.

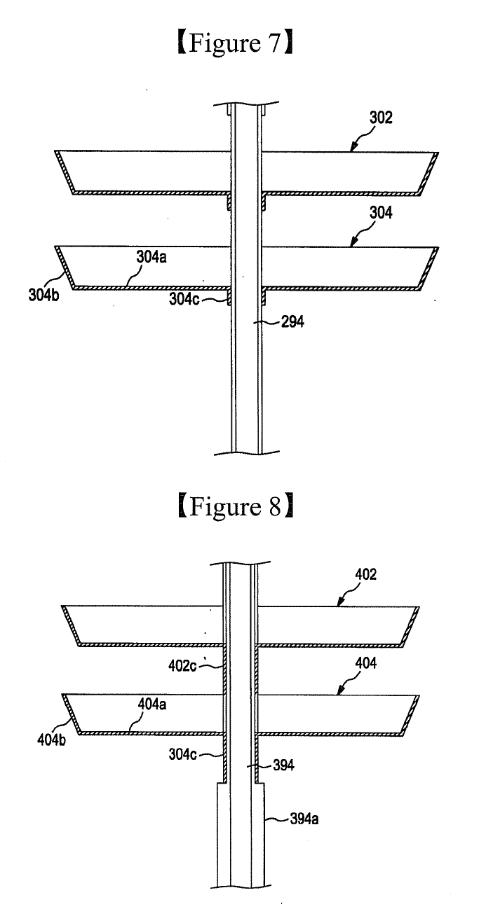

FIG. 7 shows an embodiment of the trays and the interconnection of the trays and the internal conveyance pipe. In this embodiment, the fifth tray 304 has a bottom face 304a, and a lateral face 304b extending in upward and outward direction from the perimeter of the bottom face 304a. The insertion hole for accommodating the internal conveyance pipe 294 is formed penetrating the center of the bottom face 304a, and a sleeve 304c extending downwards is formed under the bottom face 304a. The tray 304 may be fixed to the external surface of the internal conveyance pipe 294 by welding or using adhesives after the internal conveyance pipe 294 is inserted through the insertion hole of the tray 304. The shape and installation of the first through the fourth trays 296-302 are almost the same as those of the fifth tray 304.

FIG. 8 shows another embodiment of the trays and the interconnection of the trays and the internal conveyance pipe. In this embodiment, the fifth tray 404 has a bottom face 404a, and a lateral face 404b extending in upward and outward direction from the perimeter of the bottom face 404a. The insertion hole for accommodating the internal conveyance pipe 394 is formed penetrating the center of the bottom face 404a, and a sleeve 404c extending downwards is formed under the bottom face 404a. In this embodiment, a stopper 394a is formed by protruding laterally from the bottom end of the internal conveyance pipe 394, and the sleeve 404c of the fifth tray 404a is long enough to be put on the stopper 394a of the internal conveyance pipe 394. Similarly, each of the other trays is installed on the bottom face of another tray below thereof. On the other hand, it is possible to fix the contacts between each tray and the internal conveyance pipe by adhesives or welding.

The oxygen dissolving device shown in FIGS. 5 and 6 is assembled as follows.

First, the internal conveyance pipe 294 is inserted through the insertion holes of the first through the fifth trays 296-304 and fixed properly. Subsequently, the water supply tip 292 and the internal conveyance pipe 294 are fitted into the recesses 288 and 290 of the engagement portion 274, and the assembly of the lid/tray assembly 290 is accomplished. Afterwards, the lid/tray assembly 290 is engaged with the lower housing 260 using the threads. Preferably, the joints between the lid/tray assembly 270 and the lower housing 260 are provided with suitable seals such as an O-ring so as to prevent the leakage of the admixture. In one embodiment, the oxygen dissolving device 250 has a dimension of 300 millimeters height and 110 millimeters outer radius in a completely assembled state. After the oxygen dissolving device 250 is completely assembled, the first and the second elbow fittings 52 and 54 are attached in the inlet 280 and outlet 284 of the oxygen dissolving device 250, respectively.

The first inlet of the mixer 230 and the outlet of the reservoir 210 is coupled by the first connection tube 214, and the second inlet of the mixer 230 and the oxygen source is coupled by the second connection tube 222. The outlet of the mixer 230 and the inlet of the pump 240 is coupled by the third connection tube 232, and the outlet of the pump 240 and the first elbow fitting 52 in the inlet of the oxygen dissolving device 250 is coupled by the fourth connection tube 242. Afterwards, the second elbow fitting 54 in the outlet of the oxygen dissolving device 250 and the inlet of the regulating valve 320 is coupled by the fifth connection tube 322.

The apparatus shown in FIG. 4 operates as follows.

When the pump 240 is driven by applied power and oxygen gas is released from the oxygen source, the oxygen gas is introduced as bubbles into the water supplied from the reservoir 210. The water/oxygen admixture proceeds, driven by the pump 240, to the inlet of the oxygen dissolving device 250, and falls to the first tray 296 through the water supply tip 292. While the water/oxygen admixture falls and collides with the water/oxygen admixture contained in the first tray 296 and oxygen bubbles generated during the collision rises due to the buoyancy, some of the oxygen bubbles are dissolved into the water. Meanwhile, considerable portion of the oxygen bubbles exits the admixture to the upper space of the oxygen dissolving device 250.

As the first state that the first tray 296 is filled with water and the inflow of the water/oxygen admixture continues through the water supply tip 292, the water filled in the first tray 296 overflows to the second tray 298. The water falling from the first tray 296 to the second tray 298 contacts with oxygen gas filled in the inner space of the oxygen dissolving device 250, during which additional oxygen is dissolved into water. Also, while the water/oxygen admixture falls and collides with the water/oxygen admixture contained in the second tray 298 and oxygen bubbles generated during the collision rises due to the buoyancy, some of the oxygen bubbles are additionally dissolved into the water.

Consequently, as the inflow of the water/oxygen admixture continues through the water supply tip 292, the first through the fifth trays 296-304 is sequentially filled with the water/oxygen admixture, and the admixture filling a tray falls to the next tray. Finally, after the fifth tray 304 is filled with the water/oxygen admixture, the admixture overflowing the fifth tray 304 falls to and is aggregated in the bottom of the oxygen dissolving device 250.

As the pump 240 continues operation, the internal pressure of the oxygen dissolving device 250 increases, and the water/oxygen admixture aggregated in the lower section of the oxygen dissolving device 250 is forced under pressure to proceed through the internal conveyance pipe 294 and the regulating valve 320 and return to the reservoir 240 (e.g., after 1-5 minutes after the initial operation of the apparatus). The water level in the oxygen dissolving device 250 may be regulated by the regulating valve 320 in addition to the pump 240. According to an experiment of the inventors, the water level can be maintained around one-third the height of the oxygen dissolving device 250 in case that the oxygen dissolving device 250 has the above dimension. Meanwhile, as the water/oxygen admixture is filled in the first through the fifth trays 296-304 as well as in the lower section of the oxygen dissolving device 250 during the operation, the interfacial area between the oxygen and water is increased more than five times, and thus most of the residual oxygen gas is dissolved into water and the dissolved oxygen level is increased significantly. Also, the collision of the water/oxygen admixture in the first through the fifth trays 296-304 and the rise of bubbles due to buoyancy further enhances the dissolved oxygen level.

During the operation, the regulating valve 320 prevents the internal pressure of the oxygen dissolving device 250 from dropping below a certain level to maintain the internal pressure properly. When the apparatus is not working, the regulating valve 320 prevents the fluid from exiting the oxygen dissolving device 250 to maintain the internal pressure of the oxygen dissolving device 250. Thus, it is possible to reduce the idle time after the apparatus is controlled to operate again.

Since the apparatus for making oxygenated water of the present invention occupies less volume and has less weight, and can be utilized for a water purifier or a water dispenser.

In the case of applying to a water dispenser, the first through sixth connection tube 214-322 is connected to a cold water tank of the water dispenser, and all the other parts except the cold water tank can be disposed on the lower section of the water dispenser. Such a water dispenser can produce oxygenated water by circulating the cold water contained in the cold water tank regardless of the operation state.

In the case of applying to a water purifier, the first through sixth connection tube 214-322 is connected to a reservoir of the water purifier, and all the other parts except the cold water tank can be disposed on the lower section of the water dispenser.

Besides, the apparatus shown in FIGS. 4-8 can be modified in various manners.

For example, the outlet of the oxygen dissolving device may be provided near the bottom of the device even though it was described that the outlet 284 of the oxygen dissolving device 250 is provided in the lid/tray assembly 270 and the oxygenated water aggregating in the lower section of the oxygen dissolving device 250 is conveyed through the internal pipe 294.

Meanwhile, though it was described that the mixer 230 is provided between the outlet of the water reservoir 210 and the pump 240, the mixer may be disposed between the pump 240 and the oxygen dissolving device 250 alternatively.

On the other hand, though the above description was provided in terms of a small device suitable for a water dispenser or a water purifier, the apparatus for making oxygenated water of the present invention can be applied to a large scale spring water plant. In such a case, the volume of the oxygen dissolving device 250 may exceed 1 cubic meters (1 mm³), it make to much time to fill oxygen gas into the oxygen dissolving device 250. Thus, it is preferable in this case to form an oxygen inlet in the upper or middle section of the oxygen dissolving device in order to directly inject oxygen gas into the oxygen dissolving device through the oxygen inlet. Meanwhile, it is possible to provide both the mixer and the oxygen inlet in order to inject the oxygen gas through the oxygen inlet during the initial stage of operation and supply the oxygen gas through the mixer after the gas is filled in the oxygen dissolving device sufficiently. Furthermore, though it was described that the oxygen dissolving device 250 includes a lower housing 260 and a lid/tray assembly 270, the oxygen dissolving device may be manufactured into a single body using solid material such as stainless steel. Such an embodiment is suitable for large scale applications such as spring water plants.

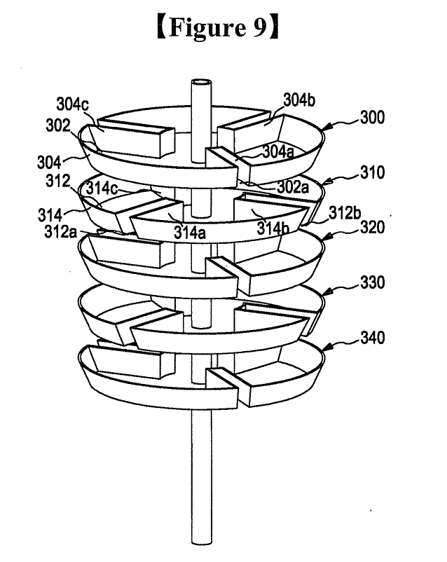

On the other hand, it is possible to modify the shape of the trays to enlarge the edges of the trays in order to increase the interfacial area between the water falling from a tray to a next one and oxygen gas existing in the dissolving device. FIG. 9 shows an example of such a tray assembly. In the example, in the first tray 300, a plurality of slits 302a are formed penetrating the bottom face of the first tray 300, and the side wall of the tray correspondingly includes recesses 304a-304c indented inward. Also, in the second tray 310, a plurality of slits 312a and 312b are formed penetrating the bottom face 312, and the side wall of the tray correspondingly includes recesses 314a-314c indented inward. Similarly, the third through the fifth trays include a plurality of slits, and the side walls of the trays include recesses indented inward. Accordingly, the water overflowing a tray to a next one overflows through external edges as well as the edges of recesses, and the interfacial area between the falling water and oxygen gas is increased significantly. Here, it is preferable to interlace the recesses of adjacent trays so that the falling water through the recesses fall onto the next tray.

Besides, although the present invention has been described in detail above, it should be understood that the foregoing description is illustrative and not restrictive. For example, the water reservoir 10 may be further provided with a check valve for relieving or recovering excessive oxygen gas buildup caused by evaporation of super saturated oxygen in the oxygenated water. Further, even though it was described that the apparatus for making oxygenated water continuously circulates the water contained in the reservoir to dissolve oxygen, it is possible to arrange a dissolved oxygen sensor in the reservoir to control the apparatus to maintain a standby state after a desired dissolved oxygen level, e.g., 90 ppm or 120 ppm, is attained.

Thus, those of ordinary skill in the art will appreciate that many obvious modifications can be made to the invention without departing from its spirit or essential characteristics. Thus, we claim all modifications and variation coming within the spirit and scope of the following claims.

### INDUSTRIAL APPLICABILITY

The apparatus for making oxygenated water according to the present invention enables dissolving oxygen in water physically without using any electrochemical catalysts or additives, and thus does not create any derivative chemicals in the oxygenated water. Accordingly, the oxygenated water made by the present invention can safely be used for drinking by human body. Such an apparatus can easily be applied to a water dispenser or a water purifier. Also, the applicant can be manufactured in large size to be used for dissolving oxygen into water bottled in a spring water factory.

Meanwhile, the apparatus of the present invention can be applied to an open reservoir as well as a closed reservoir. Thus, the apparatus can dissolve oxygen into bulky water contained in an open reservoir, and is applicable to fish farming and hydroponic culture of vegetables, or water treatment applications.

1. An apparatus for making oxygenated water, comprising:
a water reservoir containing water and having an outlet;
a pump, coupled to the outlet of said water reservoir in fluid communication, for circulating the water contained in said water reservoir;
a plurality of vertical dissolving units connected serially and coupled to said pump in fluid communication, each having a top inlet and a bottom outlet;
a turbulent dissolving tube, having an inlet connected to the outlet of the last one of the plurality of vertical dissolving units and an outlet coupled to said water reservoir in fluid communication, for introducing turbulence in water/oxygen admixture; and
a mixer, provided in the fluid path between the outlet of said water reservoir and the vertical dissolving units, for distributing oxygen from an oxygen source as bubbles in the water to produce the oxygen/water admixture.

2. The apparatus as claimed in claim 1, further comprising:
a vertical panel, and a plurality of couples of clips disposed on the lateral side of said vertical panel,
wherein said plurality of vertical dissolving units are fixed by the plurality of couples of clips.

3. The apparatus as claimed in claim 1, wherein said turbulent dissolving tube is wrapped around the outer surface of the assembly of said plurality of vertical dissolving units.

4. A water dispenser comprising a upper pad for mounting a water bottle, a cold water tank for containing cold water, a cooling coil wrapped around the outer surface of said cold water tank, and a cold water tap connected to said cold water tank, wherein said water dispenser further comprises:
an oxygen source for providing oxygen gas;
a pump, coupled to an outlet of said cold water tank in fluid communication, for circulating the water contained in said cold water tank;
a plurality of vertical dissolving units connected serially and coupled to said pump in fluid communication, each having a top inlet and a bottom outlet;
a turbulent dissolving tube, having an inlet connected to the outlet of the last one of the plurality of vertical dissolving units and an outlet coupled to said cold water tank in fluid communication, for introducing turbulence in water/oxygen admixture; and
a mixer, provided in the fluid path between the outlet of said cold water tank and the vertical dissolving units, for distributing oxygen from said oxygen source as bubbles in the water to produce the oxygen/water admixture.

5. A water purifier comprising a plurality of filters for filtering tap water to store filtered water in a reservoir, and a water tap connected to the said reservoir, wherein said water purifier further comprises:
an oxygen source for providing oxygen gas;
a pump, coupled to an outlet of said reservoir in fluid communication, for circulating the water contained in said reservoir;
a plurality of vertical dissolving units connected serially and coupled to said pump in fluid communication, each having a top inlet and a bottom outlet;
a turbulent dissolving tube, having an inlet connected to the outlet of the last one of the plurality of vertical dissolving units and an outlet coupled to said reservoir in fluid communication, for introducing turbulence in water/oxygen admixture; and
a mixer, provided in the fluid path between the outlet of said reservoir and the vertical dissolving units, for distributing oxygen from said oxygen source as bubbles in the water to produce the oxygen/water admixture.

6. An apparatus for making oxygenated water, comprising:
a water reservoir containing water and having an outlet;
a pump, coupled to the outlet of said water reservoir in fluid communication, for circulating the water contained in said water reservoir; and
an oxygen dissolving device, having an inlet coupled to said pump in fluid communication and an outlet coupled to said water reservoir in fluid communication, for dissolving oxygen from an oxygen source to water supplied by said pump,
wherein said oxygen dissolving device comprises:
a housing;
a plurality of trays installed in cascade vertically in said housing;
a water supply tip coupled to the inlet in fluid communication for providing the water supplied by said pump to a highest tray of the plurality of trays; and
means, coupled to the outlet in fluid communication, for maintaining internal pressure of said housing in a predetermined range while allowing oxygenated water to return from the outlet to said water reservoir.

7. The apparatus as claimed in claim 6, further comprising:
a mixer, provided in the fluid path between the outlet of said water reservoir and said oxygen dissolving device, for distributing oxygen from the oxygen source as bubbles in the water to produce the oxygen/water admixture.

8. The apparatus as claimed in claim 6, wherein said oxygen dissolving device has an oxygen inlet, wherein the oxygen from the oxygen source is directly injected to said oxygen dissolving device through the oxygen inlet.

9. The apparatus as claimed in claim 6, wherein said outlet of said oxygen dissolving device is formed in lower section of said oxygen dissolving device.

10. The apparatus as claimed in claim 6, wherein said outlet of said oxygen dissolving device is formed in upper section of said oxygen dissolving device.

11. The apparatus as claimed in claim 10, wherein said oxygen dissolving device further comprises:
an internal conveyance pipe for conveying water aggregating in the lower section of said oxygen dissolving device to said outlet of said oxygen dissolving device.

12. The apparatus as claimed in claim 1, wherein said trays are installed on the outer surface of said internal conveyance pipe.

13. The apparatus as claimed in claim 10, wherein said internal conveyance pipe is disposed along a center line of said oxygen dissolving device.

14. The apparatus as claimed in claim 13, wherein each of said plurality of trays has an insertion hole in its center,
wherein said internal conveyance pipe penetrates the insertion holes of said trays.

15. The apparatus as claimed in claim 6, wherein each of said plurality of trays are flat.

16. The apparatus as claimed in claim 6, wherein each of said plurality of trays has a shape of a vessel having a predetermined depth.

17. The apparatus as claimed in claim 16, wherein each of said plurality of trays has multiple openings penetrating the tray.

18. The apparatus as claimed in claim 6, wherein each of said plurality of trays has a shape of a cup.

19. The apparatus as claimed in claim 6, wherein said pressure maintaining means comprises a needle valve.

20. The apparatus as claimed in claim 6, wherein said pressure maintaining means comprises a solenoid valve.

21. The apparatus as claimed in claim 6, wherein said pressure maintaining means blocks the flow of the oxygenated water to maintain the internal pressure of said housing when the apparatus is not working.

22. A water dispenser comprising a upper pad for mounting a water bottle, a cold water tank for containing cold water, a cooling coil wrapped around the outer surface of said cold water tank, and a cold water tap connected to said cold water tank, wherein said water dispenser further comprises:
a pump, coupled to the outlet of said cold water tank in fluid communication, for circulating the water contained in said cold water tank; and
an oxygen dissolving device, having an inlet coupled to said pump in fluid communication and an outlet coupled to said cold water tank in fluid communication, for dissolving oxygen from an oxygen source to water supplied by said pump,
wherein said oxygen dissolving device comprises:
a housing;
a plurality of trays installed in cascade vertically in said housing;
a water supply tip coupled to the inlet in fluid communication for providing the water supplied by said pump to a highest tray of the plurality of trays; and
means, coupled to the outlet in fluid communication, for maintaining internal pressure of said housing in a predetermined range while allowing oxygenated water to return from the outlet to said cold water tank.

23. The water dispenser as claimed in claim 22, further comprising:
a mixer, provided in the fluid path between the outlet of said cold water tank and said oxygen dissolving device, for distributing oxygen from the oxygen source as bubbles in the water to produce the oxygen/water admixture.

24. The water dispenser as claimed in claim 22, wherein said oxygen dissolving device has an oxygen inlet,
wherein the oxygen from the oxygen source is directly injected to said oxygen dissolving device through the oxygen inlet.

25. A water purifier comprising a plurality of filters for filtering tap water to store filtered water in a reservoir, and a water tap connected to the said reservoir, wherein said water purifier further comprises:
a pump, coupled to the outlet of said reservoir in fluid communication, for circulating the water contained in said reservoir; and
an oxygen dissolving device, having an inlet coupled to said pump in fluid communication and an outlet coupled to said reservoir in fluid communication, for dissolving oxygen from an oxygen source to water supplied by said pump,
wherein said oxygen dissolving device comprises:
a housing;
a plurality of trays installed in cascade vertically in said housing;
a water supply tip coupled to the inlet in fluid communication for providing the water supplied by said pump to a highest tray of the plurality of trays; and
means, coupled to the outlet in fluid communication, for maintaining internal pressure of said housing in a predetermined range while allowing oxygenated water to return from the outlet to said reservoir.

26. The water purifier as claimed in claim 25, further comprising:
a mixer, provided in the fluid path between the outlet of said reservoir and said oxygen dissolving device, for distributing oxygen from the oxygen source as bubbles in the water to produce the oxygen/water admixture.

27. The water purifier as claimed in claim 25, wherein said oxygen dissolving device has an oxygen inlet,
wherein the oxygen from the oxygen source is directly injected to said oxygen dissolving device through the oxygen inlet.

28. An apparatus for dissolving oxygen gas into water, comprising:
a water reservoir containing water and having an outlet;
a pump, coupled to the outlet of said water reservoir in fluid communication, for circulating the water contained in said water reservoir; and
an oxygen dissolving device, having an inlet coupled to said pump in fluid communication and an outlet coupled to said water reservoir in fluid communication, for dissolving oxygen from an oxygen source to water supplied by said pump,
wherein said oxygen dissolving device comprises:
a housing having an inlet and an outlet;
a plurality of trays installed in cascade vertically in said housing;
a water supply tip coupled to the inlet in fluid communication for providing water to a highest tray of the plurality of trays; and
means, coupled to the outlet in fluid communication, for maintaining internal pressure of said housing in a predetermined range while allowing discharging of oxygenated water through the outlet.

29. The apparatus as claimed in claim 28, wherein said outlet of said oxygen dissolving device is formed in lower section of said oxygen dissolving device.

30. The apparatus as claimed in claim 28, wherein said outlet of said oxygen dissolving device is formed in upper section of said oxygen dissolving device.

31. The apparatus as claimed in claim 30, wherein said oxygen dissolving device further comprises:
an internal conveyance pipe for conveying water aggregating in the lower section of said oxygen dissolving device to said outlet of said oxygen dissolving device.

32. The apparatus as claimed in claim 31, wherein said trays are installed on the outer surface of said internal conveyance pipe.

33. The apparatus as claimed in claim 32, wherein said internal conveyance pipe is disposed along a center line of said oxygen dissolving device.

34. The apparatus as claimed in claim 33, wherein each of said plurality of trays has an insertion hole in its center,
wherein said internal conveyance pipe penetrates the insertion holes of said trays.

35. The apparatus as claimed in claim 28, wherein each of said plurality of trays are flat.

36. The apparatus as claimed in claim 28, wherein each of said plurality of trays has a shape of a vessel having a predetermined depth.

37. The apparatus as claimed in claim 36, wherein each of said plurality of trays has multiple openings penetrating the tray.

38. The apparatus as claimed in claim 36, wherein each of said plurality of trays comprises:
a flat base plate having a plurality of slits formed along its edge, each slit extending from the edge to the center and penetrating the base plate; and
a side wall extending from the base plate and the edges of the slits upward.

39. The apparatus as claimed in claim 28, wherein said housing has an oxygen inlet for injecting the oxygen.
